(19) United States
(12) Patent Application Publication
(10) Pub. No.: US 2012/0258882 A1
(43) Pub. Date: Oct. 11, 2012

(54) METHOD FOR QUANTITATIVELY DETECTING BIOMOLECULES

(75) Inventors: Chil Seong Ah, Daejeon (KR); Chang Geun Ahn, Daejeon (KR); Tae Youb Kim, Seoul (KR); Gun Yong Sung, Daejeon (KR)

(73) Assignee: Electronics and Telecommunications Research Institute, Daejeon (KR)

(21) Appl. No.: 13/443,833

(22) Filed: Apr. 10, 2012

(30) Foreign Application Priority Data
Apr. 11, 2011 (KR) 10-2011-0033357

(51) Int. Cl. C40B 30/04; B82Y 15/00

(52) U.S. Cl. 506/9; 977/773; 977/810; 977/902

(57) ABSTRACT

Provided is a method for quantitatively detecting biomolecules with high sensitivity for a short time by using nanoparticles and a metal deposition method in an immuno-detection using a well-type plastic substrate.

### CROSS-REFERENCE TO RELATED APPLICATIONS

This application is based on and claims priority from Korean Patent Application No. 2011-0033357, filed on Apr. 11, 2011, with the Korean Intellectual Property Office, the present disclosure of which is incorporated herein in its entirety by reference.

### TECHNICAL FIELD

The present invention relates to a method for quantitatively detecting biomolecules with high sensitivity for a short time by using nanoparticles and a metal deposition method in immuno-detections using a well-type plastic substrate.

### BACKGROUND

Currently, the quantitative detection of biomolecules is usually performed by using enzyme-linked immunosorbent assay (ELISA), and commercially available ELISA equipment usually uses a well-type plastic substrate. However, the ELISA equipment uses fluorescent molecules to analyze signals, and thus it takes about 2 hours to perform the analysis, which is very long. Signals are rapidly deteriorated in a low-concentration analysis of 1 ng/ml or less and it is also very difficult to ensure reproducibility, and thus it is difficult to perform an analysis with high sensitivity, which is a problem.

Thus, there is a need for developing a new analysis method by which biomolecules may be detected with high sensitivity at low costs for a short time.

### SUMMARY

The present invention has been made in an effort to provide a method for quantitatively detecting biomolecules with high sensitivity for a short time by using nanoparticles and a metal deposition method in immuno-detections using a well-type plastic substrate.

An exemplary embodiment of the present invention provides a method for quantitatively detecting biomolecules, comprising: immobilizing a first capturing molecule which may specifically bind to biomolecules to be analyzed on a well-type plastic substrate; applying a specimen including the biomolecules to be analyzed on the plastic substrate to bind the first capturing molecule to the biomolecules and then probing the biomolecules with nanoparticles bound to a second capturing molecule; applying a solution containing metal ions on the plastic substrate to grow the nanoparticles; and irradiating light on the plastic substrate to measure an amount of light transmitted.

Another exemplary embodiment of the present invention provides a method for quantitatively detecting biomolecules, comprising: immobilizing a first capturing molecule which may specifically bind to biomolecules to be analyzed on a well-type plastic substrate; probing biomolecules equal to the biomolecules to be analyzed with nanoparticles bound to a second capturing molecule to prepare a standard biomolecules, mixing the standard biomolecules with a specimen including the biomolecules to be analyzed, and then applying the mixture on the plastic substrate to bind the standard biomolecules and the biomolecules to be analyzed to the first capturing molecule; applying a solution containing metal ions on the plastic substrate to grow the nanoparticles; and irradiating light on the plastic substrate to measure an amount of light transmitted.

The present inventors have surprisingly found that in the case of the method for quantitatively detecting biomolecules as described above, the biomolecules may be detected with high sensitivity (about 10 pg/ml) at low costs for a short time (within about 20 min), as compared to using conventional ELISA. Thus, the detection method of the present invention may be applied to a commercially available ELISA equipment to enhance the possibility of commercialization (within 10% of coefficient of variation (CV)). Because quantitative analysis may be performed with high sensitivity at low costs for a short analysis time, a rapid kit for screening may be manufactured into a rapid kit, which makes a quantitative analysis possible, and when the well-type plastic substrate consists of a plurality of wells or is manufactured in the form of an array, various or multiple target biomolecules may be simultaneously and effectively detected.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

FIG. 1A is a schematic view schematically illustrating a method for quantitatively detecting biomolecules by a sandwich immunoassay according to an exemplary embodiment of the present invention.

FIG. 1B shows an anticipated detection result of target biomolecules according to the sandwich immunoassay of FIG. 1A.

FIG. 2A is a schematic view schematically illustrating a method for quantitatively detecting biomolecules by a competitive immunoassay according to another exemplary embodiment of the present invention.

FIG. 2B shows an anticipated detection result of target biomolecules according to the competitive immunoassay of FIG. 2A.

FIG. 3 schematically shows a multi-well type plastic substrate according to an exemplary embodiment of the present invention.

FIG. 4 schematically shows an array-well type plastic substrate according to another exemplary embodiment of the present invention.

FIG. 5 shows an apparatus for detecting biomolecules according to an exemplary embodiment of the present invention.

FIG. 6 shows an image after the coating of silver (Ag) according to the TROPONIN I-CARDIAC (cTnI) antigen concentration in Example 1.

FIG. 7 shows absorbance and a detection result according to the TROPONIN I-CARDIAC antigen concentration in Example 1 (analysis time: 1 hr).

FIG. 8 shows absorbance and a detection result according to the TROPONIN I-CARDIAC antigen concentration in Example 2 (analysis time: 20 min).

### DETAILED DESCRIPTION

In the following detailed description, reference is made to the accompanying drawing, which form a part hereof. The illustrative embodiments described in the detailed description, drawing, and claims are not meant to be limiting. Other embodiments may be utilized, and other changes may be made, without departing from the spirit or scope of the subject matter presented here.

Hereinafter, a method for quantitatively detecting biomolecules according to the present invention will be described in detail with reference to the accompanying drawings.

The present invention provides a method for quantitatively detecting biomolecules with high sensitivity for a short time by using nanoparticles and a metal deposition method in an immuno-detection using a well-type plastic substrate.

According to an exemplary embodiment, the detection method of the present invention comprises immobilizing a first capturing molecule which may specifically bind to biomolecules to be analyzed on a well-type plastic substrate; applying a specimen including the biomolecules to be analyzed on the plastic substrate to bind the first capturing molecule to the biomolecules and then probing the biomolecules with nanoparticles bound to a second capturing molecule; applying a solution containing metal ions on the plastic substrate to grow the nanoparticles; and irradiating light on the plastic substrate to measure an amount of light transmitted.

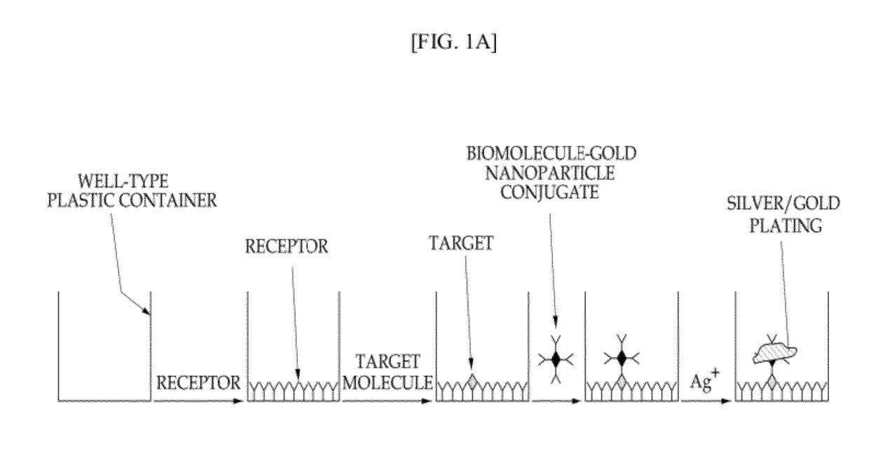

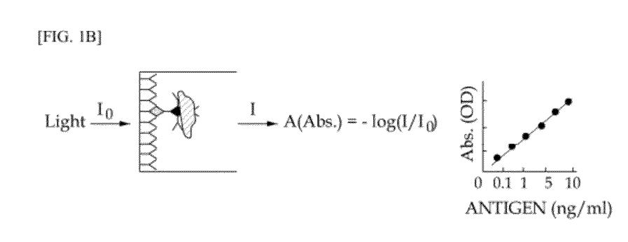

The binding of the first capturing molecule with the biomolecules and then probing of the biomolecules with nanoparticles bound to the second capturing molecule is performed by a sandwich immunoassay, and a specific example thereof is shown in FIG. 1A.

Referring to FIG. 1A, nanoparticles may be marked on biomolecules in a manner of immobilizing a first capturing molecule (for example: receptor) on the plastic substrate surface, binding target biomolecules to the immobilized first capturing molecule, and then binding a second capturing molecule-nanoparticle conjugate, to which a second capturing molecule (for example: biomolecule, biomaterial) and nanoparticles (for example: gold nanoparticles) are bound, to the biomolecules immobilized on the plastic substrate.

According to another exemplary embodiment, the detection method of the present invention comprises: immobilizing a first capturing molecule which may specifically bind to biomolecules to be analyzed on a well-type plastic substrate; probing biomolecules equal to the biomolecules to be analyzed with nanoparticles bound to a second capturing molecule to prepare standard biomolecules, mixing the standard biomolecules with a specimen including the biomolecules to be analyzed, and then applying the mixture on the plastic substrate to bind the standard biomolecules and the biomolecules to be analyzed to the first capturing molecule; applying a solution containing metal ions on the plastic substrate to grow the nanoparticles; and irradiating light on the plastic substrate to measure an amount of light transmitted.

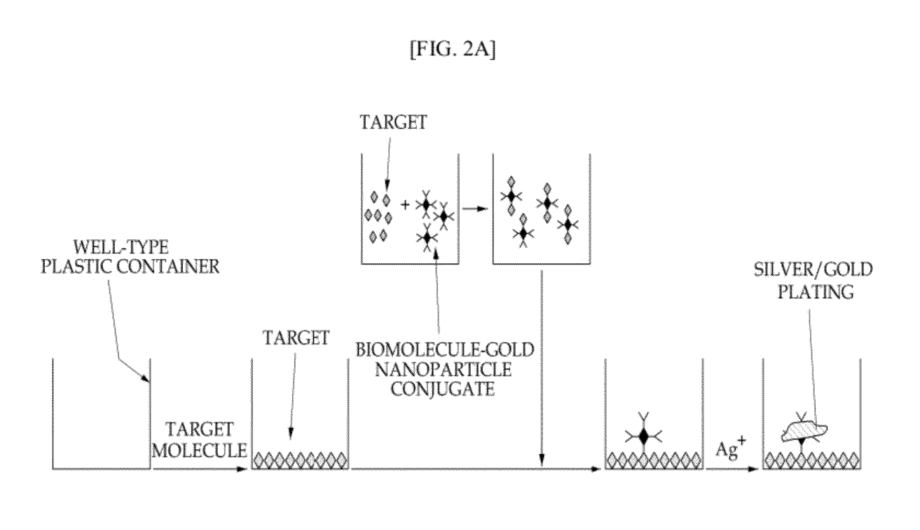

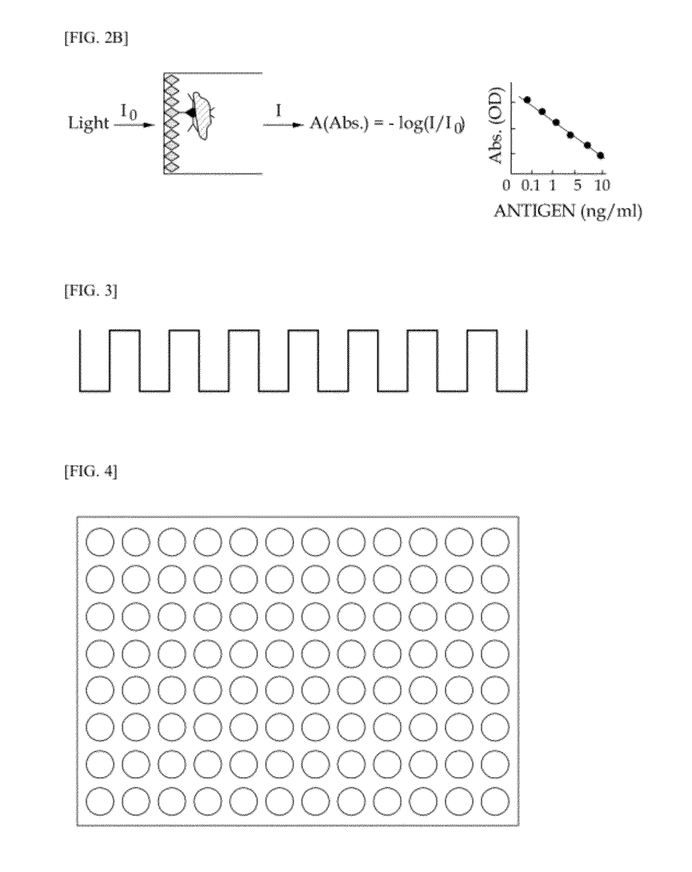

The mixing of the standard biomolecules with the specimen including the biomolecules to be analyzed and then applying of the mixture on the substrate to bind the standard biomolecules and the biomolecules to be analyzed to the first capturing molecule is performed by a competitive immunoassay, and a specific example thereof is shown in FIG. 2A.

The size, number, arrangement, and the like of the wells formed on the plastic substrate are not particularly limited. The well may consist of a plurality of numbers (see FIG. 3) or in the form of an array (see FIG. 4), and accordingly, various kinds of or a plurality of target biomolecules may be simultaneously detected.

The plastic substrate uses those on which a surface treatment may be performed by using general chemicals used in the manufacture of a biosensor such that a first capturing molecule may be immobilized on biomolecules, and the surface treatment may be performed by those skilled in the art using a known method appropriately according to the kind of specimen to be measured, the kind of biomolecules, the kind of first capturing molecule, and the like.

A first capturing molecule immobilized on the plastic substrate surface and a second capturing molecule bound to biomolecules captured by the first capturing molecule may use anything as long as the capturing molecules are biomolecule which may be bound to biomolecules by antigen-antibody specific binding, DNA complementary binding, specific reactivity of organic chemicals, and the like. For example, the first capturing molecule and the second capturing molecule may be each selected from small molecules such as antigens, antibodies, DNAs, RNAs, PNAs, haptens, aptamers, avidins, biotins, ligands, amino acids, food toxins or hormones, and used, but are not always limited thereto. The first capturing molecule and the second capturing molecule may be the same as or different from each other.

A biomolecule to be a target in the present invention is not limited, but may be one of small molecules such as antigens, antibodies, viruses, DNAs, RNAs, cells, food toxins or hormones, and the like.

A specimen (sample) including the biomolecules is not always limited thereto, but virus cultured, bacteria, extract derived from cells or tissue, blood, plasma, serum, grain, and the like may be used.

In the present invention, nanoparticles are bound as a marker (or probe) material to a second capturing molecule which binds to biomolecules, and these nanoparticles are more inexpensive and more stable than marker materials in the related art, such as enzymes, fluorescent materials, and the like, make a more reliable analysis possible, and may be grown by a metal deposition solution to be described below to amplify signals significantly, which are advantageous.

These nanoparticles are not particularly limited as long as the average particle diameter satisfies a range of 0.1 to 300 nm, and may be gold, silver, copper, platinum, palladium, and the like. Preferably, gold nanoparticles or silver nanoparticles may be used.

As used herein, the term “second capturing molecule-nanoparticle conjugates” is interpreted to mean nanoparticles to which a second capturing molecule is physically or chemically linked or in which the second capturing molecule is functionalized.

The second capturing molecule-nanoparticle conjugates may be easily prepared in a laboratory, specifically binds to target biomolecules present in the well of a plastic substrate, and is present in the well of the plastic substrate in proportion to the number of target biomolecules.

The immobilizing of the biomolecules on the plastic substrate and the probing of the biomolecules with nanoparticles may be stably performed generally at a temperature in a range of 1 to 40° C., and is not always limited to the temperature range. The reaction time may be within about 50 min and preferably within 10 min.

The biomolecules are marked (or probed) with nanoparticles, and then a solution containing metal ions is applied on the nanoparticles which have marked the biomolecules to grow the nanoparticles.

When the concentration of the target biomolecules is low, the signal is so weak that it is not easy to observe and identify the change thereof. However, if the solution containing metal ions is applied to nanoparticles which have marked the biomolecules, metal ions are coated on the surfaces of the nanoparticles while being reduced to metal, and nanoparticles may be grown to block light effectively and thus signals may be amplified to observe the change in signals effectively. The degree of coating of the reduced metal may be easily controlled by controlling the application time of the solution containing metal ions and the concentration of metal ions contained in the solution. The longer the application time and the higher the concentration of metal ions contained in the solution are, the degree of coating of the reduced metal increases.

The reduction reaction may be performed generally at a temperature in a range of 1 to 40° C. for 30 min or less and preferably for 0.1 min to 15 min.

The metal ion to be reduced may be gold, silver, copper, platinum, palladium, and the like and preferably gold or silver ion.

The reduction of the metal ions to metal may also be performed in the presence of a reducing agent, such as hydroquinone, hydroxylamine, and the like.

Next, light is irradiated on the plastic substrate to measure an amount of light transmitted.

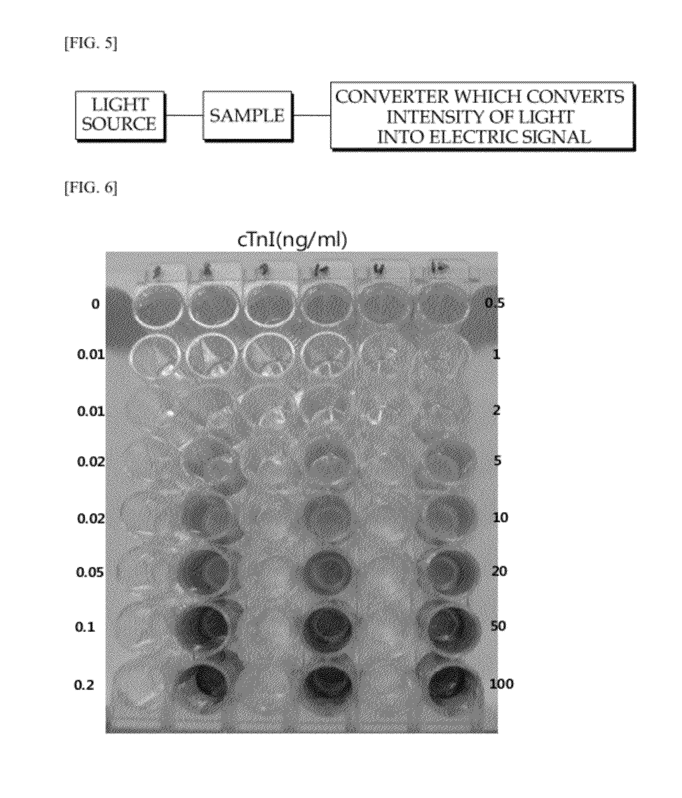

As described above, if the reduced metal is coated and then light is irradiated on the plastic substrate to measure an amount of light transmitted on the plastic substrate, the presence and concentration of target biomolecules may be confirmed. For this purpose, absorbance may be measured generally in a wavelength from 300 to 800 nm. FIG. 1B is a result for a sandwich immuno-detection and shows that the higher the concentration of biomolecules to be analyzed is, the higher the value of absorbance is, and FIG. 2B is a result for a competitive immuno-detection and shows that the higher the concentration of biomolecules to be analyzed is, the lower the value of absorbance is. FIG. 5 illustrates an apparatus for detecting biomolecules according to an exemplary embodiment of the present invention, and if light from a light source is irradiated on a specimen (sample) to be measured, light transmitted is converted into an electric signal value by a converter which converts the intensity of light into an electric signal. As the light source, photodiode, LED, LCD, and the like may be used.

According to the above-described quantitative detection method of biomolecules, the biomolecules may be detected with high sensitivity (about 10 pg/ml) at low costs for a short time (within about 20 min). When it is contemplated that a well-type plastic substrate is usually used in the ELISA equipment in the conventional art, which is not easy to achieve high sensitivity nor reduce the analysis time, if the detection method of the present invention is applied to the commercially available ELISA equipment, the possibility of commercialization may be enhanced, which is advantageous (within 10% of coefficient of variation (CV)). Because quantitative analysis may be performed with high sensitivity at low costs for a short analysis time, a rapid kit for screening may be manufactured as a rapid kit, which makes a quantitative analysis possible, and when the well-type plastic substrate consists of a plurality of wells or is manufactured in the form of an array, various or multiple target biomolecules may be simultaneously and effectively detected and thus the kit is very practical.

Hereinafter, the present invention will be described in detail through the following Examples. However, the following Examples are only to illustrate the present invention and the present invention is not limited by the following Examples.

### Example 1

In the present Example, a method for detecting a TROPONIN I-CARDIAC antigen as target biomolecules after immobilizing a TROPONIN I-CARDIAC (cTnI) antibody on a well-type plastic substrate and results thereof are shown.

Specifically, a TROPONIN I-CARDIAC antibody (Merdian Life Science) was immobilized on a well-type plastic substrate purchased from Nunc, Inc., and then a specimen including the TROPONIN I-CARDIAC antibody and a TROPONIN I-CARDIAC antibody-gold nanoparticle conjugate were mixed together, followed by reaction for 50 min. Herein, the antigen was purchased from Merdian Life Science, Inc., the gold nanoparticles were purchased from Ted Pella, Inc., the TROPONIN I-CARDIAC antibody-gold nanoparticle conjugate was directly prepared and used in a laboratory. The concentration of the TROPONIN I-CARDIAC antigen in the sample was controlled to 0, 0.01, 0.02, 0.05, 0.1, 0.2, 0.5, 1, 2, 5, 10, 20, 50, and 100 ng/ml and the TROPONIN I-CARDIAC antibody-gold nanoparticle conjugate was used at a concentration of 4.5 nM.

Subsequently, a solution containing silver (Ag) ions (Sigma, Inc., Silver Enhancer Kit (SE100)) was applied on the surface of the substrate for 12 min to allow metal silver (Ag) to be coated on the antibody-gold nanoparticle conjugate. FIG. 6 shows an image after the coating of silver (Ag) according to the TROPONIN I-CARDIAC antigen concentration. Referring to FIG. 6, it may be known that as the TROPONIN I-CARDIAC concentration increased, the silver coating greatly proceeded.

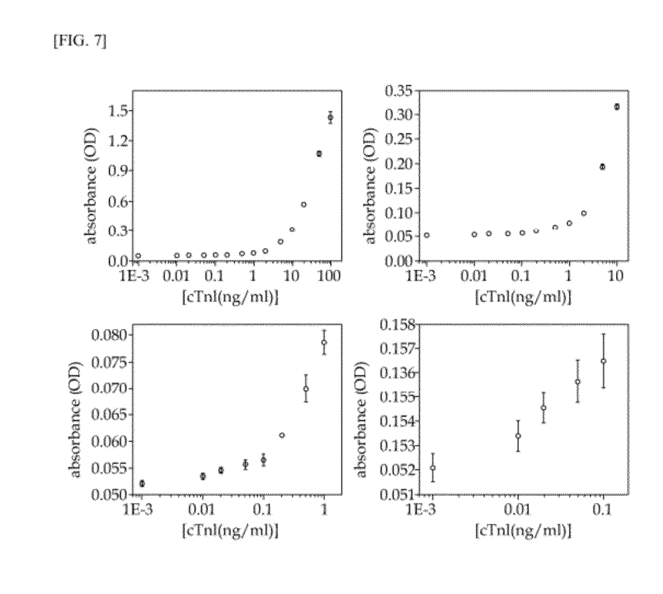

Subsequently, absorbance (measurement wavelength: 450 nm) was measured and the result is shown in FIG. 9. In the present experiment, six plastic substrates were used for each concentration of the antigen, and error bars for these results are shown in FIG. 7.

Referring to FIG. 7, it may be known that the detection limit was less than 10 pg/ml and the sensitivity was very good.

### Example 2

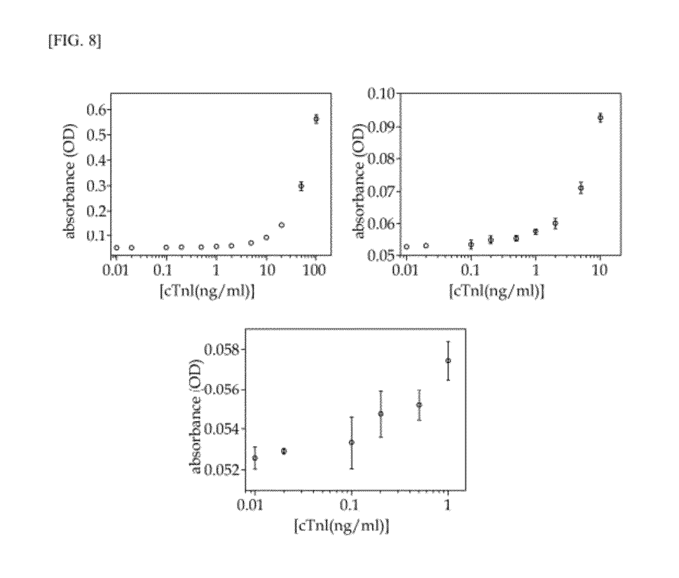

In the present Example, an antigen was detected in the same manner as in Example 1, except that the antigen specimen was mixed with the antibody-gold nanoparticle conjugate and then allowed to react for 10 min. The result is shown in FIG. 8.

Referring to FIG. 8, it may be known that it was possible to perform detection even in a very short time, the detection limit was also less than 10 pg/ml, and the sensitivity was very good.

From the foregoing, it will be appreciated that various embodiments of the present invention have been described herein for purposes of illustration, and that various modifications may be made without departing from the scope and spirit of the present invention. Accordingly, the various embodiments disclosed herein are not intended to be limiting, with the true scope and spirit being indicated by the following claims.

What is claimed is:

1. A method for quantitatively detecting biomolecules, comprising:
immobilizing a first capturing molecule which may specifically bind to biomolecules to be analyzed on a well-type plastic substrate;
applying a specimen including the biomolecules to be analyzed on the plastic substrate to bind the first capturing molecule to the biomolecules and then probing the biomolecules with nanoparticles bound to a second capturing molecule;
applying a solution containing metal ions on the plastic substrate to grow the nanoparticles; and
irradiating light on the plastic substrate to measure an amount of light transmitted.

2. The method of claim 1, wherein the first capturing molecule and the second capturing molecule are each independently at least one selected from the group consisting of antigens, antibodies, DNAs, RNAs, PNAs, haptens, aptamers, avidins, biotins, ligands, amino acids, food toxins, and hormones.

3. The method of claim 1, wherein the biomolecules are at least one selected from the group consisting of antigens, antibodies, viruses, DNAs, RNAs, cells, food toxins, and hormones.

4. The method of claim 1, wherein the nanoparticles are at least one metal nanoparticle selected from the group consisting of gold, silver, copper, platinum, and palladium.

5. The method of claim 1, wherein the metal ion is at least one metal ion selected from the group consisting of gold, silver, copper, platinum, and palladium.

6. A method for quantitatively detecting biomolecules, comprising:
immobilizing a first capturing molecule which may specifically bind to biomolecules to be analyzed on a well-type plastic substrate;
probing biomolecules equal to the biomolecules to be analyzed with nanoparticles bound to a second capturing molecule to prepare standard biomolecules, mixing the standard biomolecules with a specimen including the biomolecules to be analyzed, and then applying the mixture on the plastic substrate to bind the standard biomolecules and the biomolecules to be analyzed to the first capturing molecule;
applying a solution containing metal ions on the plastic substrate to grow the nanoparticles; and
irradiating light on the plastic substrate to measure an amount of light transmitted.

7. The method of claim 6, wherein the first capturing molecule and the second capturing molecule are each independently at least one selected from the group consisting of antigens, antibodies, DNAs, RNAs, PNAs, haptens, aptamers, avidins, biotins, ligands, amino acids, food toxins, and hormones.

8. The method of claim 6, wherein the biomolecules are at least one selected from the group consisting of antigens, antibodies, viruses, DNAs, RNAs, cells, food toxins, and hormones.

9. The method of claim 6, wherein the nanoparticles are at least one metal nanoparticle selected from the group consisting of gold, silver, copper, platinum, and palladium.

10. The method of claim 6, wherein the metal ion is at least one metal ion selected from the group consisting of gold, silver, copper, platinum, and palladium.
